(19) United States
(12) Patent Application Publication
(10) Pub. No.: US 2010/0122119 A1
(43) Pub. Date: May 13, 2010

(54) METHOD TO MANAGE PERFORMANCE MONITORING AND PROBLEM DETERMINATION IN CONTEXT OF SERVICE

(75) Inventors: Georg Bildhauer, Nufringen (DE); Ulrich Hild, Holzgerlingen (DE); Juergen Holtz, Pleidelsheim (DE)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/269,533

(22) Filed: Nov. 12, 2008

(51) Int. Cl. G06F 11/00

(52) U.S. Cl. 714/47; 714/E11.02

(57) ABSTRACT

A method to manage performance monitoring and problem determination in a context of a service application is provided. The method includes distributing performance monitoring reusable templates to the computing system that describe a set of required monitoring products, a set of scenarios with key performance indicators (KPI) relevant to the service application, and a set of best practices solutions describing how a potential performance incident is to be handled, during instantiation of the service application, deriving from the reusable templates actual performance monitoring characteristics related to various selected components of the computing system, and customizing the reusable templates to the service application in accordance with the actual performance monitoring characteristics by determining whether a number and a type of monitoring agents and/or scenarios with associated KPIs are to be changed, determining whether different KPIs exist and by determining whether solutions exist for an incident.

### BACKGROUND

Aspects of the present invention are directed to a method to manage performance monitoring and problem determination in a context of a service.

Currently, performance monitoring is typically achieved on the basis of an information technology (IT) infrastructure. That is, resource data is collected and reported on for each individual server within the infrastructure. Another approach, less widely used, employs an end-to-end view from an application perspective. Both methods are similar in that they usually relate to certain organizations and typical observations of many IT service providers is that the different parts of the organizations are silo-like structures, where communication and non-tool based business process management between the silos is relatively slow and error prone. On the other hand, application landscapes in modern IT services may be fuzzy and, in these cases, the corresponding organizations lose a benefit of an overview of all the inter-dependencies between servers, middleware, and applications.

These realities lead to the proposed solution of providing application landscapes as a service with clearly defined boundaries and to tailor the scope of performance monitoring and problem determination to only what is required to manage the given service.

Thus, as an example, IBM Tivoli provides a so-called process automation engine that consists of a workflow engine to define and control IT service management workflows. Based on the process automation engine and its tooling, a couple of service management processes have been implemented and are currently available. There are also products in the market that already provide a more application-centric view on performance. An example of such a product is IBM Tivoli Composite Application Management for Response Time Tracking (ITCAM RTT). Such products allow for the tracking of application performance from an end-to-end perspective. That is, they show different transaction components and provide hints on where potential bottlenecks may occur. Moreover, some tools, like IBM Tivoli Monitoring V5 in combination with the Tivoli Management Framework (TMF) provide some sort of profile management that allows for the placing of common configuration information for machines used for similar purposes in a centralized area.

### SUMMARY

In accordance with an aspect of the invention, a method to manage performance monitoring and problem determination in a context of a service application supportive of a computing system is provided. The method includes distributing performance monitoring reusable templates to the computing system that describe a set of monitoring products (herein also referred to as “monitoring agents”) required for the service application in support of the computing system, a set of monitoring scenarios with key performance indicators (KPI) relevant to the service application, and a set of best practices solutions how a potential performance incident is to be handled for the service application, during instantiation of the service application in support of the computing system, deriving from the reusable templates actual performance monitoring characteristics related to various selected components of the computing system, and subsequently customizing the reusable templates to the service application in accordance with the actual performance monitoring characteristics by determining whether a number and a type of monitoring agents and/or scenarios with associated KPIs are to be maintained, increased or decreased, determining whether different KPIs exist and by determining whether best practices solutions exist for an incident detected within the computing system.

### BRIEF DESCRIPTIONS OF THE SEVERAL VIEWS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a service package lifecycle in accordance with embodiments of the invention;

FIG. 2 illustrates a relationship between a service package and an instantiated service;

FIG. 3 illustrates components of a service package in accordance with embodiments of the invention;

FIG. 4 illustrates components of an instantiated service package in accordance with embodiments of the invention; and

FIG. 5 illustrates a workflow for an instantiated service package in accordance with embodiments of the invention.

### DETAILED DESCRIPTION

In accordance with an aspect of the present invention, a capability to deploy an application landscape as a service that can be selected from, e.g., the Tivoli Service Catalog, is provided such that performance management is made an integral part of a service. The service itself is conceived as a set of templates, stored within, e.g., a memory unit of a computing system, and, with them, performance monitoring templates are defined by a processing unit of the computing system. Such performance monitoring templates describe a monitoring infrastructure within a context of the service template. That is, the monitoring templates determine what types of monitors are supported and what scenarios they need to supervise. The monitoring templates also describe the best practices of how to respond to certain issues and provide selected management plans (i.e., workflows) with both automated and manual steps that can be employed to resolve the issues. Thus, in accordance with aspects of this invention, a scope of performance monitoring and problem determination is tailored to only what is required to manage a given service and, furthermore, by mapping disciplines with best practices service management processes, previously unrelated organizations may be brought together so that a holistic monitoring and problem determination approach is possible. As such, performance analysis and reporting may be accomplished in a context of a specific service application rather than on a larger IT scope.

In an embodiment of the invention, a Service Automation Manager product provides for deployment of an application landscape as a service application. As an exemplary part of such a service application, to install, for example, a WebSphere cluster running on an AIX connected to a DB2 database on z/OS, applicable performance monitors can be selected, installed, and configured on various target systems. Since, from one instance of such a service to another, the actual degree and scope of performance monitoring can vary as needed by the corresponding IT organization, discovery capabilities can be exploited to reuse existing monitoring infrastructure where such capabilities are available. This exploitative capability brings performance management closer to the business management as what is needed and what is applicable to manage the performance of a service can be selectively chosen.

The product offers a set of supported monitoring agents. Depending on the target platform, where the components of the service application are going to be installed, the appropriate set of monitoring agents is recommended and the responsible administrator can choose particular monitoring agents from this set. The performance agents, or rather, monitors, are additionally configured to supervise common performance and/or availability scenarios for a given service. In case of the occurrence of critical issues, events are generated and reported and a problem determination workflow may be initiated that provides, e.g., subject matter experts (SMEs), with information reflective of service-specific best practices to guide the SMEs to resolve the issues.

Application landscapes are typically built by different organizations rather than being created in a service-centric way. As such, to be successful, a typical IT service provider is faced with several challenges, including cross-silo interaction and the handling of service management processes. In cross-silo interaction, monitoring needs to be set up for all relevant servers in the infrastructure, such as the required monitors that are installed and active to negotiate and thereby determine the required monitors that need to be active, monitoring needs to be configured for application-specific requirements to negotiate and thereby determine the scenarios with their key performance indicators (KPIs), incidents need to be handled in a timely manner, and changes related to a particular service need to be reflected in other services. At the same time, challenges result from the handling of service management processes due to the lack of tools that ensure that processes are executed efficiently across different parts of the organization and to ensure that a holistic approach, where performance monitoring and problem determination for performance incidents is designed into the product as a core function for service fulfillment, is provided.

Other challenges to the typical IT service provider include the fact that existing process automation tools do not allow for the provision of a complete infrastructure for a service including the provisioning and configuration of the related performance monitors as well. Often, performance monitoring products only work with instrumented applications and such products are generally installed and managed separately from the various organizations in a data center. Also, ongoing changes within the infrastructure, the application, or any other component needed for the fulfillment of a service require administrators to revisit performance monitoring settings and any changes must be inputted manually. Still further, when performance monitors are deployed in different environments compared to which they have been originally configured for, the IT service provider must ensure that the profiles are adapted to fit the purpose of the new environment. This again is typically a manual task, disconnected to the main task dealing with the service offering itself

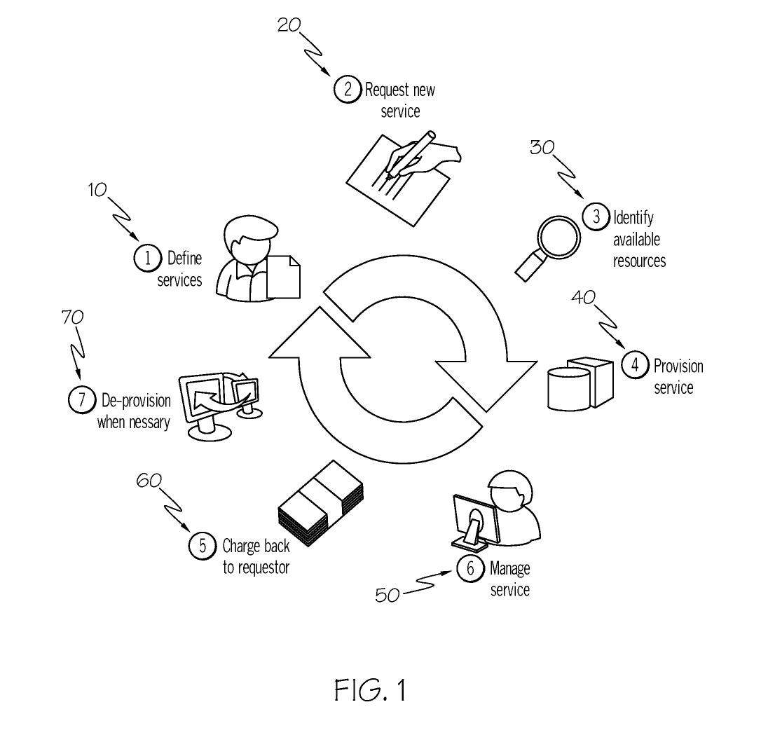

With the above in mind, with reference to FIG. 1, a service lifecycle may be understood as follows. First, a service needs to be defined and provided in a form of a service package 10. For example, an IT service provider decides to provide a service for his clients that allows the clients to deploy a WebSphere cluster within a heterogeneous environment to be deployed and managed in accordance with best practices. The service definition describes all the characteristics of this cluster and serves as a template for specific service instances that can be bought by the clients. Clients can then subscribe to the service and pay for the fulfillment of this service based on service level agreements (SLA) negotiated between a client and the IT service provider 20. The IT service provider then insures that the resources required for the service are available so that the SLA can be met 30, creates a specific instance package and completes that package with the necessary resource assignments, and deploys that instance package by installing and configuring the package on the assigned machines 40. The IT service provider, subsequently, manages the service based on the SLA 50. In case of service interruptions of any sort (for example decreased performance, lack of high-availability, outage, etc.), the IT service provider's responsibility is to restore the agreed service levels as soon as possible. The client pays the IT service provider for the service based on the SLA 60 and the client resigns the contract when the service is no longer needed 70.

In accordance with aspects of the present invention, integrated, service-centric performance monitoring and problem determination for performance incidents is provided within each phase of the service lifecycle.

In general, performance management is an integral part of a service. Services are defined as templates, referred to as service packages, and, with them, performance monitoring templates are defined as well. The performance monitoring template describes the monitoring infrastructure within the context of the corresponding service template, determines what types of monitors are supported and additionally determines what scenarios they are required to supervise. Finally, the performance monitoring template also describes the available best practices as to how to respond to certain issues and provides management plans, such as workflows with both automated and manual steps, which may be used to help to resolve these issues.

When a service is instantiated from a given template, a performance monitoring instance is created that uses the information defined in the template as an initial set of definitions to start with. Of course, a user interface, for example the flexible browser-based UT of Tivoli's process automation engine, is provided that allows an administrator to tailor the performance monitoring instance to the specific needs of a service instance.

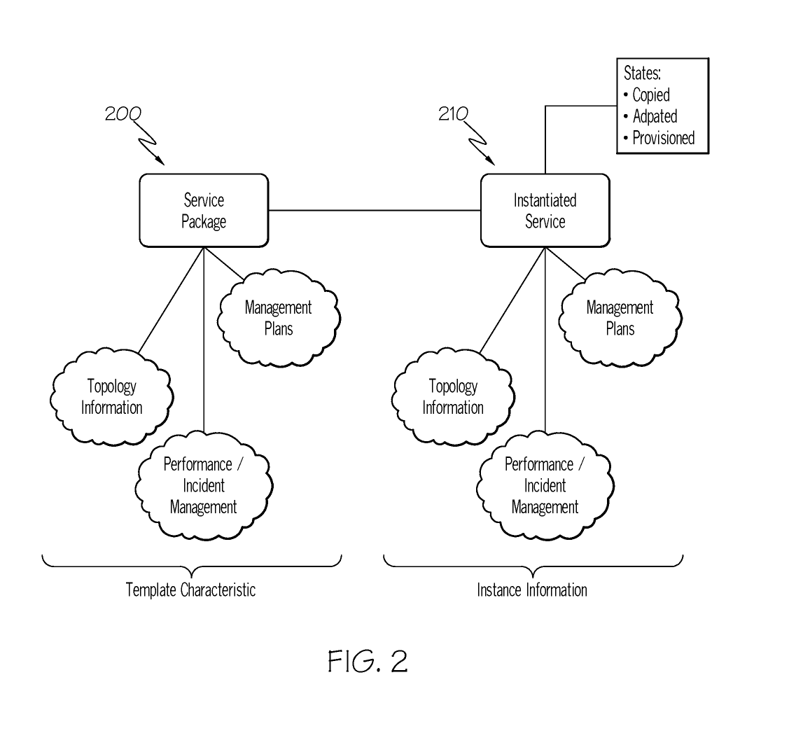

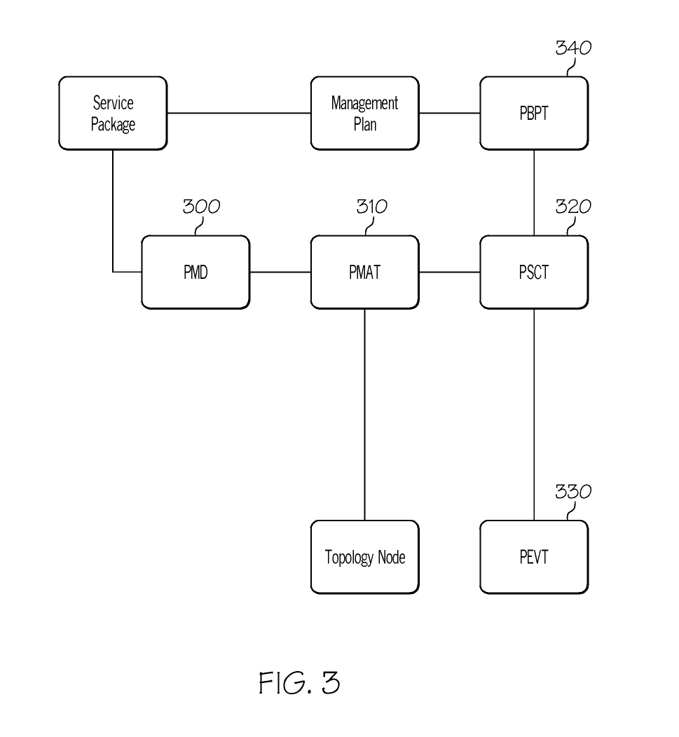

As shown in FIGS. 2-4, the performance monitoring definition/instance is related to a service package 200 and to an instantiated service 210. The overall anchor for this model is the service package 200. A performance monitoring definition (PMD) 300 describes the common characteristics of the monitoring environment for the given service package. Examples of these characteristics may include the name of a monitoring server and its communication parameters, where all monitoring data is accumulated and from which event monitoring is controlled.

Attached objects include a set of agent types (PMAT) 310 where commonalities among different agents can be defined. An example of an agent type is an ITM Linux OS agent for test systems. Another example of an agent type could be an ITM Linux OS agent for production systems. The difference between both is described by the scenarios (PSCT) 320 each agent type is monitoring and the specific set of events of interest (PEVT) 330. A typical scenario includes the monitoring of critical processor utilization. The events representing critical processor utilization can include looping processes, latent demand for work to be dispatched, and high overall processor utilization due to workload, and others. The difference is further described by the best practices (PBPT) 340 that are associated with each and every scenario and which contain details as to how to proceed in a case of an incident and that document the courses of actions to follow when analyzing a particular event. For example, the best practices may list a number of sources where more detailed and background information for a given incident can be found. It could also describe a methodology to dig deeper into a problem to find its root cause. Other best practices are provided that tell the user how to automatically or semi-automatically solve the performance incident. Using the example above, a looping process could be killed. Or if the hardware allows it, another processor or system could be added. The best practices may be assigned with management plans that are defined for that very service package and so it is possible to drive specific actions depending on a specific scenario, detected by a specific agent type within a specific service instance, automatically.

During instantiation, the service package data model, including the performance and incident management related components are copied to create the instantiated service 210 or rather the instantiated service package 210. Because the data model is copied from a service package 200 to an instantiated service package 210, it is possible to adapt the characteristics of the service package to the special needs for a given instantiated service package. Originally, these instance-level objects inherit the information from the definition level. However, the actual attributes, for example, what agent is running on what server can vary from one instance to another instance.

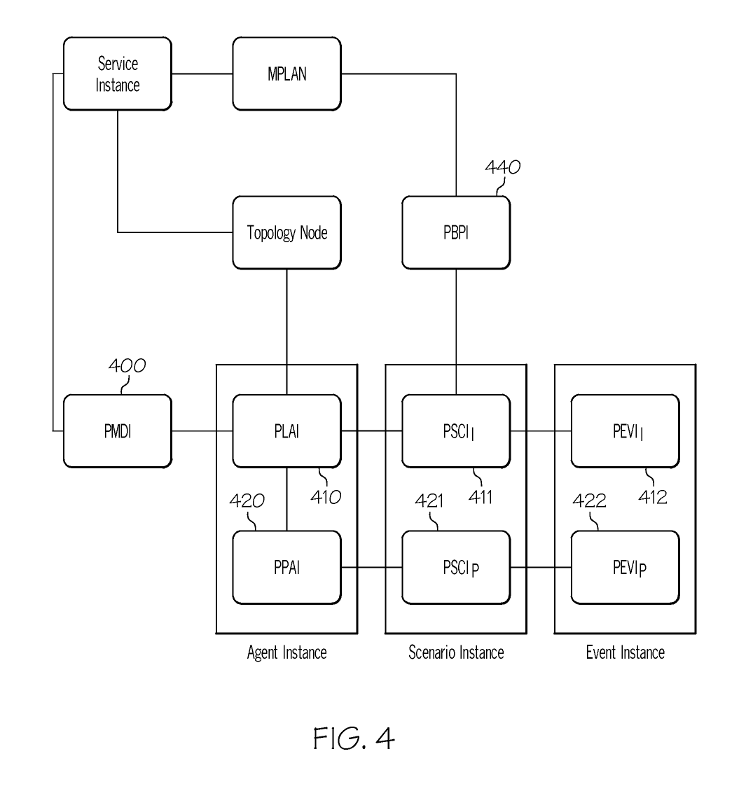

With reference to FIG. 4, the PMDI object 400 corresponds to the PMD object 300 and the PBPI object 440 corresponds with the PBPT object 340. Here, the I-suffix emphasizes that the object is an instance level object. On the instance level, the user can tailor the performance monitoring setup using, e.g., the browser UI that comes with Tivoli's process automation engine, to add, change, or remove agents, scenarios and events. For example, in a test environment, the monitoring for CPU utilization may be of little interest and could be removed. Conversely, where CPU utilization monitoring may be a must for a production environment, such removal may be optional but maintained as part of the service instance.

The data model also caters for cases where the same physical resource may be shared by different logical resources. Take, for example, the case where two topology nodes that each belong to a different instantiated service package have been assigned to the same physical server (co-hosting). For monitoring it may be necessary to have a distinct agent for each topology node in some cases, where it may be necessary to have one common agent covering both topology nodes in other cases. To be prepared for either case, a logical agent (PLAI) is distinguished from a physical agent (PPAI) on the instance level. Similarly, scenarios (PSCI) 411, 421 and events (PEVI) 412, 422 are kept on both levels. Having the data laid out in this manner, provides for flexibility to serve both monitoring scenarios.

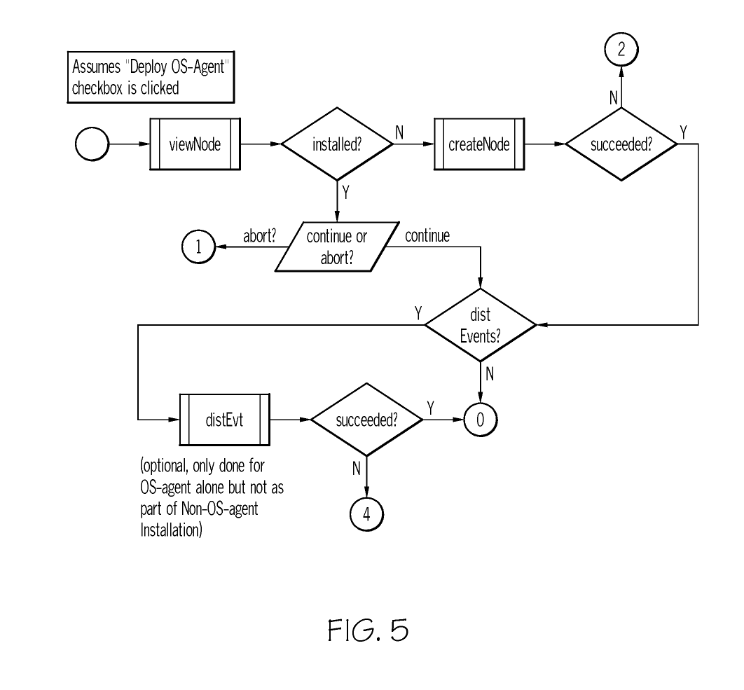

When the service is actually created, performance monitoring agents are installed on the various components that have been selected as part of the instantiation of the service. Reuse of existing monitoring infrastructure on a case-by case basis is supported as well to allow the service to be seamlessly integrated into an existing environment. The monitors are configured to report to an installation-determined collection focal point (a monitoring server as marked in the PMDI) and to raise events in case of any violation of the supervised scenarios. When a service is terminated, the product also caters for removing any traces that have been created upon instantiation of the service. As an example, the instantiation workflow for an IBM Tivoli Monitoring OS agent is provided in FIG. 5.

As shown in FIG. 5, the activities viewNode, createNode, and distEvt are placeholders for the real monitoring product being used. The workflow is triggered during creation of the instantiated service package. This ensures that the deployment of the agent is achieved in a context of an overall service being provided. The workflow can run fully automated and it can be changed and customized easily by the user. The “0” circle represents the positive end of the workflow while the “1,” “2” and “4” circles represent error situations. In an error situation, the workflow can return with a particular return code which can be used to trigger a dialog with the user to interrogate further processing steps. For example, one can let the user investigate what the reason for the failure was, let him fix it, and then re-drive the workflow.

As is further shown in FIG. 5, monitoring events are distributed to the agent this is recently deployed. The monitoring events that are distributed are derived from the scenarios (PSCI) and from the events (PEVI) within each scenario, as introduced above. The events are proxies for concrete pre-defined exceptional situations that are distributed, and thus activated, during the distEvt activity. A performance monitor, configured in this manner, raises an event for each situation if the corresponding condition is met. Normally, those events are captured centrally. However, it is understood that the events could be also routed to some general event console. In this case, it is the responsibility of the operator seeing the event to determine what happened, who is affected, and who has to be informed.

In accordance with aspects of the present invention, the event is further fed into a process framework, as described in the patent application entitled, “Incident Classification and Assignment of Subject Matter Expert for Error Resolution.” As such, a problem determination workflow can be initiated. The problem determination workflow automatically adds context information to the reported issue and helps to quickly isolate and resolve the event in order to minimize the service interruption.

Once the service is no longer needed, the operations mentioned above are ended. If events have been distributed, they will be withdrawn. If agents have been deployed, they will be de-installed. In co-hosting situations, the physical removal of the service will only take place when the last logical agent is removed.

In accordance with aspects of the present invention, performance monitoring and problem determination for performance incidents is provided in the context of a service. In an embodiment of the invention, a product supports the deployment of performance monitors and its configuration according to pre-defined best practices, when the related service is instantiated. The default characteristics of performance monitoring are described in a form of reusable templates, such as service packages, as an integral part of any given service that describe what monitoring product(s) are required for the service, what the scenarios with their key performance indicators (KPI) that matter for that service are, and the best practices solutions describing how a potential performance incident should be handled for the service. During instantiation of a service, the actual characteristics of performance monitoring are derived from the template through copy and, subsequently, they can be customized to the specific needs of the service to determine whether more or less monitoring agents are needed, whether more or less KPIs are needed, to determine whether different KPIs are needed, and to determine whether any specific solutions exist for an incident. All selected products are installed and configured automatically for all the infrastructure components selected for a given service, i.e. OS, middleware, and applications. This leads to holistic monitoring and problem determination in a context of a service.

It is understood that the present invention can be embodied as a computer readable storage medium having executable instructions stored thereon to execute a method to manage performance monitoring and problem determination in a context of a service application.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method to manage performance monitoring and problem determination in a context of a service application supportive of a computing system, the method comprising:
distributing performance monitoring reusable templates to the computing system that describe one or more monitoring products required for the service application in support of the computing system, one or more scenarios with their key performance indicators (KPI) relevant to the service application, and one or more best practices describing how a potential performance incident is to be handled for any given scenario for the service application;
during instantiation of the service application in support of the computing system, deriving from the reusable templates actual performance monitoring characteristics related to various selected components of the computing system; and
subsequently customizing the reusable templates to the service application in accordance with the actual performance monitoring characteristics by determining whether a number and a type of monitoring products and/or scenarios with associated KPIs are to be maintained, increased or decreased, determining whether different KPIs exist and by determining whether best practices solutions exist for an incident detected within the computing system.

2. The method according to claim 1, wherein the monitoring products are installed and configured automatically for all of the various selected components.

3. The method according to claim 2, wherein the service application comprises an operating system (OS) monitor.

4. The method according to claim 2, wherein the service application comprises a middleware monitor.

5. The method according to claim 2, wherein the service application comprises an application monitor.

6. The method according to claim 1, wherein multiple service applications partly or fully share monitoring products on a same physical computer system.

7. The method according to claim 1, wherein the monitoring products are de-installed automatically for all components upon termination of the service.

8. The method according to claim 1, wherein the monitoring products are reused in an event they are already installed on some or all of the selected computer systems.
